(19) United States
(12) Patent Application Publication
(10) Pub. No.: US 2025/0385488 A1
(43) Pub. Date: Dec. 18, 2025

(54) GAS-FILLED SPARK GAP

(71) Applicant: CITEL, PARIS (FR)

(72) Inventors: Vincent CREVENAT, PARIS (FR); Cong Duc PHAM, PARIS (FR); Yves GANNAC, PARIS (FR); Vincent LAPAUW, PARIS (FR)

(21) Appl. No.: 19/235,031

(22) Filed: Jun. 11, 2025

(30) Foreign Application Priority Data
Jun. 14, 2024 (FR) 2406343

(51) Int. Cl. H01T 4/10

(52) U.S. Cl. CPC H01T 4/10

(57) ABSTRACT

A gas-filled spark gap for the protection of an electric installation has an electrically-insulating body, two electrodes fixed to the electrical-insulating body and spaced from one another in a main direction, an inter-electrode space formed in the electrically-insulating body between the two electrodes, two connecting terminals intended to enable electrical connection of the gas-filled spark gap to the electric installation being electrically-connected to a respective one of the two electrodes, an inter-electrode space including a diverter channel defining a propagation trajectory for an electric arc, and a gas trapped in the inter-electrode space, the gas being selected from argon Ar, neon Ne, nitrogen N2, hydrogen H2, helium He and mixtures thereof.

### TECHNICAL FIELD

The invention relates to the general field of devices for protecting all types of circuits, installations, electrical equipment and networks against transient voltage surges.

The invention relates more particularly to the field of lightning arrestors and surge suppressors employing gas-filled spark gaps for the protection of circuits, installations or electrical equipment and networks against transient voltage surges due in particular to lightning strikes.

### TECHNOLOGICAL BACKGROUND

Electrical or data transmission networks can be subject to transient voltage surges and current surges. Industrial and manoeuvring disturbances generated by starting or stopping motors or alternators, switching power supply networks or the fall of electrical cables at different voltages are for example liable to cause transient voltage surges and current surges. Furthermore, if these networks include cables suspended above the ground and fixed to electrical posts or other structures over long distances they are particularly liable to be struck by lightning.

Lightning is characterised by an impulse discharge current of high peak intensity with a rise time of the order of one microsecond. Lightning can typically cause voltage surges of several million volts and current surges of thousands of amperes. Now, electrical or data transmission networks are not designed to withstand such transient voltage surges and current surges.

To protect these networks it is known to use protection devices generally known as lightning arrestors, surge arrestor devices or surge arrestors, the object of which is to divert the impulse currents to earth, which makes it possible to peak limit the voltage surges to values compatible with the withstand voltages of the electrical installations and the equipment to which they are connected.

Known in particular from FR 3 017 004 are lightning arrestors employing gas-filled spark gaps. Such a gas-filled spark gap is a hermetically-sealed electrical component including two conductive electrodes separated by an insulating ceramic inside which a gas is trapped. In normal operation of the electrical network, that is to say in the absence of a voltage surge, the gas-filled spark gap has a very high insulation resistance, which can be considered as virtually infinite. On the other hand, if it is subjected to a transient voltage surge the value of which is above the initiation voltage of the gas-filled spark gap set by the pressure of the gas an electric arc is formed by ionisation of this gas situated between the electrodes. The gas-filled spark gap is struck suddenly and becomes conductive with a low impedance. The gas-filled spark gap is then similar to a short circuit that diverts to earth a high discharge current corresponding to the transient voltage surge. It is therefore possible to protect electrical circuits downstream of the gas-filled spark gap against the impulse currents by evacuating the latter to earth via the gas-filled spark gap.

In the behaviour of a spark gap, it is therefore possible to distinguish four states of operation: rest, corona, arc and extinction.

The rest state is characterised by a practically infinite insulation resistance.

In the corona state the conductance increases suddenly after initiation. If the current flowing through the gas-filled spark gap is less than about 0.5 ampere (an approximate value varying with the various types of spark gap) the so-called corona voltage at the terminals will be 80-100 volts.

The arc regime is then established: the current increasing, the gas-filled spark gap goes from the corona voltage to the arc voltage. It is in this state that the gas-filled spark gap is the most effective since the current flowing can be as high as several thousand amperes without the arc voltage at its terminals significantly increasing.

Finally comes the extinction of the spark gap: for a polarisation voltage almost equivalent to the corona voltage the spark gap reverts to its initial insulation characteristics after the disturbance has ceased.

Such gas-filled spark gaps are designed to have good resistance to shock currents, typically 100 KA. A shock current is defined as the maximum current that can be withstood without destruction or dispersion of the electrical initiation characteristics following the passage of a 10/350 μs wave representing the lightning current generated in the event of a direct strike.

However, the weak point of a sealed gas-filled spark gap is its extinction capability. Containing a gas in a sealed enclosure means that after initiation of the spark gap and passage of the lightning current the gas becomes hot and ionised. The gas-filled spark gap being part of the network the current in the network is then able to circulate via this ionised gas, in theory in an infinite manner.

In fact, once struck the gas-filled spark gap has flow through it a part of the current in the network, referred to as the follow current. As opposed to an air spark gap, the gas is not able to escape from the enclosure and therefore cannot be blown out, which would extinguish the current. This greatly limits the extinction capability: the gas-filled spark gap can extinguish only a low network current (of the order of hundreds of amperes).

For the spark gap to be able to be extinguished correctly the operating voltage of the network to be protected must be lower than the spark gap minimum arc voltage. It is therefore advantageous to increase the arc voltage at the terminals of the spark gap when the latter is in the arc regime.

### SUMMARY OF THE INVENTION

An idea behind the invention is to produce a gas-filled spark gap having an improved follow current extinction capability while preserving its electrical characteristics in terms of initiation and withstanding shock currents.

An embodiment of the invention provides a gas-filled spark gap for the protection of an electric installation, including:
an electrically-insulating body;
two electrodes fixed to the electrically-insulating body and spaced from one another in a main direction;
an inter-electrode space formed in the electrically-insulating body between the two electrodes, the inter-electrode space being closed in gas-tight manner;
two connecting terminals intended to enable electrical connection of said gas-filled spark gap to the electric installation, the two connecting terminals being electrically-connected to a respective one of said two electrodes, the inter-electrode space including a diverter channel defining a propagation trajectory for an electric arc, a cross-section of the diverter channel being between 2 and 8 mm², the diverter channel extending transversely or obliquely to the main direction over at least a part of the length of the diverter channel; and
a gas trapped in the inter-electrode space

In an embodiment the gas is selected from argon Ar, neon Ne, nitrogen N2, hydrogen H2, helium He and mixtures thereof.

Thanks to these features, the propagation trajectory is defined by the diverter channel. In other words the electric arc is first forced to propagate along a propagation trajectory defined by the shape of the diverter channel. It is then possible to increase the length of the arc by defining a propagation trajectory including at least one turn, even at least one half-turn. The length of the arc is therefore increased and this results in an arc voltage that is also increased. Thanks to the increased arc voltage arc extinction is facilitated.

In an embodiment the gas-filled spark gap further includes an initiation chamber formed at one end of the inter-electrode space to strike an electric arc.

In an embodiment, a cross-section of the inter-electrode space including the diverter channel and the initiation chamber is constant.

In an embodiment the gas-filled spark gap further includes at least one initiation element positioned in the initiation chamber.

In an embodiment the initiation element includes an initiation electrode separated from the two electrodes and one or more lines of graphite.

It is therefore possible to initiate the arc by the initiation element initiating a spark.

In an embodiment the initiation electrode is electrically connected to passive electronic components adapted to initiate an electric arc between the initiation electrode and one of the two electrodes following reception of a transient voltage surge.

In an embodiment a length of the inter-electrode space is between 6 mm and 10 mm.

The arc therefore has a length between 6 mm and 10 mm since the inter-electrode space defines the propagation trajectory thanks to its small cross-section.

In an embodiment the gas-filled spark gap has an initiation voltage greater than 200 V.

In an embodiment the insulating body is made of ceramic, for example of alumina.

In an embodiment the electrodes are made of copper or an alloy of steel and nickel or any other suitable metal or alloy.

In an embodiment the gas-filled spark gap has the general shape of a rectangular or circular cross-section right cylinder.

### BRIEF DESCRIPTION OF THE FIGURES

The invention will be better understood and other aims, details, features and advantages thereof will become more clearly apparent in the course of the following description of particular embodiments of the invention given by way of non-limiting illustration only with reference to the appended drawings.

FIG. 1 represents diagrammatically an electrical installation in which embodiments of the invention can be used.

FIG. 2 represents diagrammatically a gas-filled spark gap according to a first embodiment.

FIG. 3 is a view in section taken along the line III-III in FIG. 2.

FIG. 4 is a view analogous to FIG. 3 that represents diagrammatically a gas-filled spark gap according to a second embodiment.

FIG. 5 represents diagrammatically a gas-filled spark gap according to another embodiment.

FIG. 6 represents diagrammatically a gas-filled spark gap according to a further embodiment.

FIG. 7 represents diagrammatically a gas-filled spark gap according to a yet further embodiment.

FIG. 8 is a graph representing as a function of time the voltage at the terminals of a gas-filled spark gap according to an embodiment.

### DESCRIPTION OF EMBODIMENTS

The embodiments described hereinafter refer to a gas-filled spark gap intended to limit transient voltage surges in an electric or data transmission network including an electric line to be protected, for example a telecommunication network or a network for transporting energy at very high power such as a high-voltage network or a medium-voltage or low-voltage network.

The gas-filled spark gap described hereinafter is more generally intended to be connected to all types of apparatus, installation or network fed with electricity and liable to suffer transient disturbances, notably due to lightning strikes. Such a gas-filled spark gas can therefore advantageously constitute a lightning arrestor.

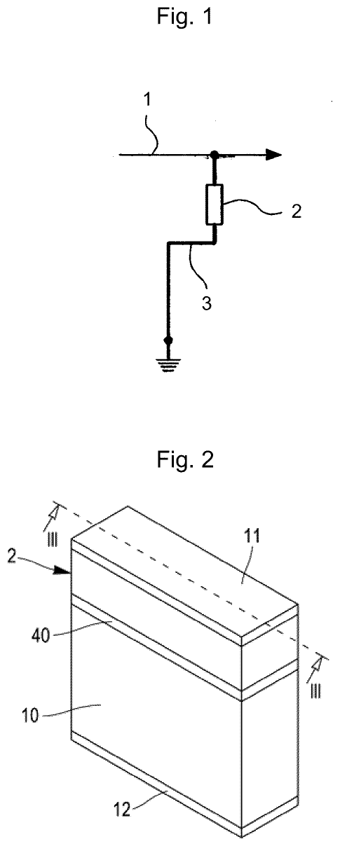

Referring to FIG. 1, an electric line 1 to be protected is connected by a gas-filled spark gap 2 to another electric line 3, for example an earth line, another discharge line or any other electric line of the network. The gas-filled spark gap 2 is therefore branch-connected (or parallel-connected) to the electric line 1 to be protected.

The electric line 1 to be protected carries an AC or DC voltage.

### Gas-Filled Spark Gap

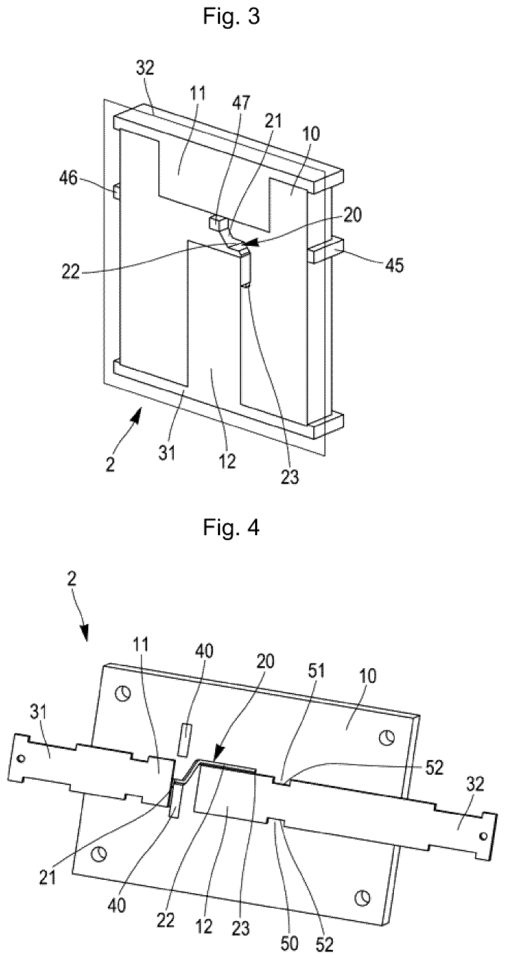

Referring to FIGS. 2 and 3, the gas-filled spark gap 2 includes an insulating body 10 of parallelepipedal shape made for example of ceramic at the ends of which two electrodes 11 and 12 are positioned. The electrodes 11 and 12 are spaced from one another by the insulating body 10 in a main direction of the gas-filled spark gap 2.

The electrically-insulating body 10 can be made of ceramic materials, preferably of alumina. The electrically-insulating body 10 is preferably covered by a casing or a coating providing mechanical protection and electrical insulation, for example made of plastic material, notably PBT or PA. Alternatively, insulating materials other than ceramics can be employed to produce the electrically-insulating body 10.

Referring to FIG. 2, the electrodes 11 and 12 include exterior portions accessible from outside the insulating body and interior portions inserted in housings recessed into the insulating body 10. The exterior portions of the electrodes 11 and 12 extending outside the insulating body 10 therefore form connecting terminals 31 and 32. These connecting terminals 31 and 32 form electric connection interfaces in order to enable connection of the gas-filled spark gap 2 to the electric line 1 to be protected.

For example, the first connecting terminal 31 can be electrically connected to the electric line 1 to be protected and the second connecting terminal 32 can be electrically connected to an earthing connection.

The connecting terminal 31 or 32 and the electrode 11 or 12 here form a one-piece member. Alternatively, each electrode 11, 12 is electrically connected to a connecting terminal 31, 32 by a connection means.

There is a recessed inter-electrode space 20 in the insulating body 10 between the first electrode 11 and the second electrode 12. The insulating body 10 and the two electrodes 11 and 12 are assembled in a gas-tight manner, for example by soldering, so that the inter-electrode space 20 is completely isolated from the surrounding atmosphere. In other words, the electrodes 11 and 12 are fixed to the insulating body 10 in a sealed manner, for example by soldering.

The inter-electrode space 20 takes the form of a narrow channel that defines a propagation trajectory T for an electric arc between the two electrodes 11 and 12. It comprises successively:
an initiation chamber 21 in the vicinity of the internal portion of the first electrode 11,
a diverter channel 22 deviating the propagation trajectory T obliquely to the main direction to lengthen the propagation trajectory, and
a contact chamber 23 in the vicinity of the internal portion of the second electrode 12.

In an embodiment that is not represented the diverter channel 22 includes at least one half-turn or an elbow. In other words the diverter channel 22 includes a first portion extending from the first electrode 11 toward the second electrode 12 and a second portion extending in the opposite direction, i.e. from the second electrode 12 toward the first electrode 11. In this embodiment the general shape of the diverter channel 22 can be an “S” shape.

The initiation chamber 21 is where the electric arc is struck. The electrode 11 forms at least one wall of the initiation chamber 21. The initiation chamber 21 can further include at least one initiation element, for example one or more lines of graphite fixed to the insulating body 10 in the initiation chamber 21.

The initiation element further includes an initiation electrode 40. This initiation electrode 40 can be electrically connected to passive electronic components such as resistors, coils and/or capacitors. These passive electronic components initiate the striking of the arc in response to a transient voltage surge (due to a lightning strike or other cause) received at the terminals of the gas-filled spark gap 2.

Like the electrodes 11 and 12, the initiation electrode 40 includes exterior portions 45, 46 accessible from outside the insulating body and interior portions inserted in recessed housings in the insulating body 10. The insulating body 10 and the initiation elements 40 are assembled in gas-tight manner, for example by soldering, so that the inter-electrode space 20 is completely isolated from the surrounding atmosphere.

An internal portion 47 of the initiation electrode 40 is inside the inter-electrode space 20. Referring to FIG. 3, the internal portion 47 is situated in the initiation chamber 21. In an embodiment that is not represented the internal portion 47 can be situated inside the diverter channel 22.

The initiation generated by the transient voltage surge thanks to the passive electronic components occurs between the internal portion 47 and the electrode 11 after which the arc is established between the electrode 11 and the electrode 12. In an embodiment that is not represented the initiation electrode 40 comprises a plurality of internal portions 47.

The inter-electrode space 20 has a cross-section between 1 and 10 mm², for example between 2 and 8 mm². In an embodiment the cross-section of the inter-electrode space is constant.

Referring to FIG. 3, the inter-electrode space 20 is formed by a space left free inside the insulating body 10.

The walls of the inter-electrode space 20 are formed by the insulating body 10. Furthermore, a part of one of the electrodes 11, 12 can form a part of the walls of the inter-electrode space 20. For example in FIG. 6 the electrode 12 forms a part of the wall of the inter-electrode space 20.

The inter-electrode space 20 therefore includes the electrode 11 at a first end and the electrode 12 at the second end.

Referring to FIGS. 2 and 3, the main direction of the gas-filled spark gap corresponds to the direction in which the electrode 11 and the electrode 12 are inserted in the insulating body 10.

In order to ensure that the gas is trapped in the gas-filled spark gap 2 the latter is sealed. The gas trapped in the inter-electrode space 20 of the gas-filled spark gap 2 is for example argon Ar, neon Ne, nitrogen N2, hydrogen H2, helium He, or a mixture of those gases. The gas advantageously includes hydrogen H2. This gas is stored in the gas-filled spark gap 2 at an absolute pressure from 0.5 bar (50 kPa) to 2 bar (200 kPa). As indicated this pressure influences the initiation voltage of the gas-filled spark gap 2. The gas can therefore be trapped in the gas-filled spark gap 2 at different pressures depending on the required initiation voltage. In an embodiment the trapped gas is an argon-hydrogen mixture containing 10% hydrogen at a pressure of 1300 mBar.

For example, a layer of molybdenum-manganese can be used to seal the electrically-insulating body 10, this layer of molybdenum-manganese being itself covered by a layer of nickel. The electrically-insulating body 10 can be sealed by melting Ag—Cu solder.

Alternatively the electrically-insulating body 10 can be sealed by Ag—Cu—Ti solder deposited directly on the surface of the insulating body 10 in contact with the electrode.

Another way to produce this sealed closure is gluing by means of a glue compatible with aluminas. A further technique consists in using a seal and mechanically clamping the two parts onto this seal.

There is next described with reference to FIG. 8 a result obtained experimentally using a gas-filled spark gap 2 as described above.

A normalised 10/1000 μs shape current wave is applied to the terminals of the gas-filled spark gap 2. In known manner a 10/1000 μs current wave is characterised by a rise time of 10 μs and a total duration of 1000 μs.

FIG. 8 shows the arc voltage at the terminals of the gas-filled spark gap 2 expressed in V on the ordinate axis as a function of time expressed in ms on the abscissa axis.

It is found that an arc voltage of 200 V is established in a stable manner in less 1 ms with a peak voltage greater than 300 V. After to 5 to 6 ms the arc voltage drops to zero. In other words, the arc is extinguished after between 5 and 6 ms or the extinction of the arc occurs at the end of 5 to 6 ms.

The operation of a gas-filled spark gap 2 as described above is described next.

When a transient voltage surge associated with an impulse current exceeds the initiation voltage of the gas-filled spark gap 2 an electric arc is struck in the initiation chamber 21.

In the inter-electrode space 20 the electric arc is guided along the propagation trajectory T by the gas present in the inter-electrode space 20 between the initiation chamber 21 and the contact chamber 23.

As explained above, the length of the propagation trajectory T, i.e. the distance di, is increased thanks to its transverse component or components.

The arc voltage is therefore increased since the resistance of the arc is directly proportional to its length.

Furthermore, in addition to the capacity to define the propagation trajectory T, the inter-electrode space 20 enables reduction of the cross-section of the arc. Now, if the area of the cross-section of the arc is reduced the voltage necessary to maintain the arc is increased. The cross-section of the discharge channel 22 therefore enables the arc voltage to be increased.

The gas-filled spark gap 2 therefore enables a sufficiently high arc voltage to be obtained, which facilitates extinguishing the arc.

While preserving the electrical characteristics of a gas-filled spark gap in terms of striking and withstand current the gas-filled spark gap 2 therefore makes it possible to improve the extinction power.

### Other Embodiments

A second embodiment of the gas-filled spark gap 2 is described next with reference to FIG. 4. Elements analogous or identical to those of the first embodiment bear the same reference numbers. Only the differences are described hereinafter.

In this embodiment the electrodes 11, 12 are two metal strips inserted from opposite faces of the electrically-insulating body 10. The main direction of the inter-electrode space 20 therefore corresponds overall to the horizontal direction in FIG. 4.

In this embodiment the electrodes 11, 12 each have at their end a connecting terminal 31, 32. In this case, the main direction of the inter-electrode space 20 corresponds to the straight line segment passing through the two connecting terminals 31, 32.

In this embodiment fixing the electrodes 11, 12 to the electrically-insulating body 10 is facilitated by ribs 51 on the electrically-insulating body 10 engaged in notches 52 on the electrodes 11 and 12. The notches 52 are situated on two opposite edges of the metal strips.

Furthermore, in this embodiment the gas-filled spark gap 2 is closed by a cover (not represented).

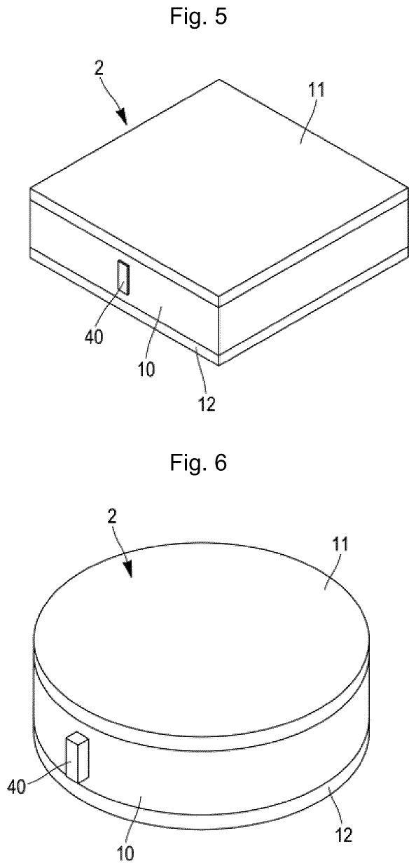

In another embodiment depicted in FIG. 5, the electrodes 11, 12 being inserted from lower and upper faces of the electrically-insulating body 10, the main direction of the inter-electrode space 20 corresponds globally to the vertical direction in the figure. In this embodiment the gas-filled spark gap 2 has a block or right-angle parallelepiped general shape.

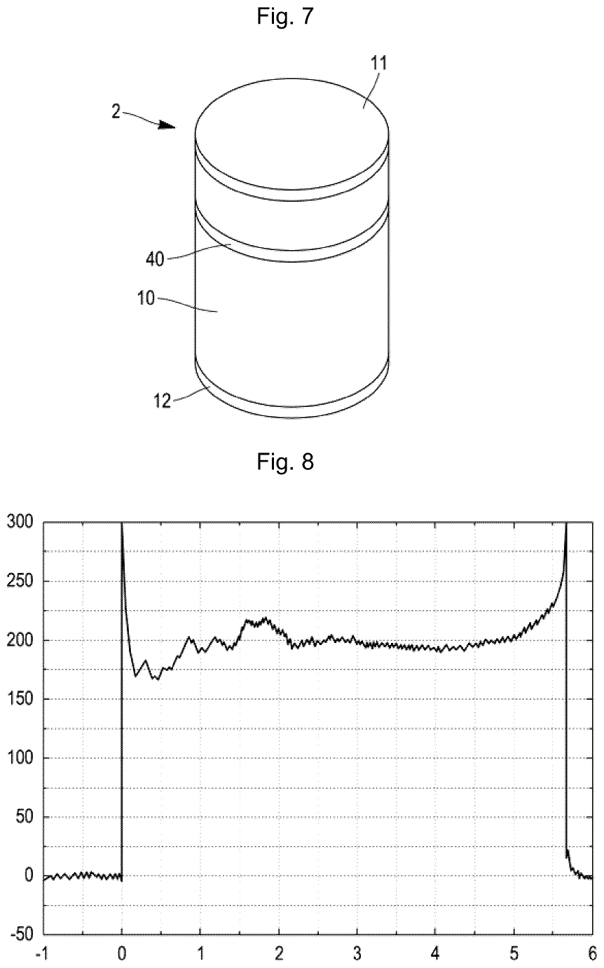

In a variant depicted in FIGS. 6 and 7 the gas-filled spark gap can have the general shape of a right cylinder.

Although the invention has been described with reference to particular embodiments it is obvious that it is in no way limited to them and that it encompasses all technical equivalents of the means described and combinations thereof if the latter are within the scope of the invention.

Use of the verb “to include” or “to comprise” and conjugate forms thereof does not preclude the presence of elements or steps other than those stated in a claim.

In the claims any reference sign between parentheses should not be interpreted as a limitation of the claim.

1. A gas-filled spark gap (2) for protection of an electric installation, including:
a. an electrically-insulating body (10);
b. two electrodes (11; 12) fixed to the electrically-insulating body and spaced from one another in a main direction;
c. an inter-electrode space (20) formed in the electrically-insulating body between the two electrodes, the inter-electrode space being closed in gas-tight manner;
d. two connecting terminals (31; 32) intended to enable electrical connection of said gas-filled spark gap to the electric installation, the two connecting terminals being electrically-connected to a respective one of said two electrodes;
e. the inter-electrode space including a diverter channel (22) defining a propagation trajectory (T) for an electric arc; a cross-section of the diverter channel (22) being between 2 and 8 mm², the diverter channel extending transversely or obliquely to the main direction over at least a part of a length of the diverter channel; and
f. a gas trapped in the inter-electrode space, the gas being selected from argon Ar, neon Ne, nitrogen N2, hydrogen H2, helium He and mixtures thereof.

2. The gas-filled spark gap according to claim 1, wherein an initiation chamber (21) is formed at one end of the diverter channel to strike the electric arc.

3. The gas-filled spark gap according to claim 2, wherein at least one initiation element (40) is positioned in the initiation chamber.

4. The gas-filled spark gap according to claim 3, wherein the initiation element includes an initiation electrode (40) separated from the two electrodes.

5. The gas-filled spark gap according to claim 4, wherein the initiation electrode is electrically connected to passive electronic components adapted to initiate striking of the electric arc between the initiation electrode and one of the two electrodes following reception of a transient voltage surge.

6. The gas-filled spark gap according to claim 3, wherein the initiation element includes one or more lines of graphite.

7. The gas-filled spark gap according to claim 2, wherein a cross-section of the inter-electrode space including the diverter channel (22) and the initiation chamber (21) is constant.

8. The gas-filled spark gap according to claim 1, wherein the length of the diverter channel (22) is between 6 mm and 10 mm.

9. The gas-filled spark gap according to claim 1, wherein the two electrodes (11; 12) are made of copper or an alloy of steel and nickel.

10. The gas-filled spark gap according to claim 1 has a general shape of a right cylinder of rectangular or circular cross-section.

11. The gas-filled spark gap according to claim 1, wherein the electrically-insulating body is made of ceramic.
